(19) United States
(12) Patent Application Publication
(10) Pub. No.: US 2023/0187687 A1
(43) Pub. Date: Jun. 15, 2023

(54) PROCESS FOR FLUORINATION OF AN LLZO GARNET

(71) Applicants: Solvay SA, Brussels (BE); Centre National de la Recherche Scientifique, Paris (FR); Clermont Auvergne INP, Aubiere Cedex (FR); Universite Clermont Auvergne, Clermont-Ferran (FR)

(72) Inventors: Laure Bertry, Aubervilliers (FR); Réka Toth, Paris (FR); Thierry Le Mercier, Rosny-Sous-Bois (FR); Valérie Buissette, Paris (FR); Katia Guerin, Pont Du Chateau (FR); Marc Dubois, Metz (FR); Michaël Herraiz, Vendat (FR)

(73) Assignees: Solvay SA, Brussels (BE); Centre National de la Recherche Scientifique, Paris (FR); Clermont Auvergne INP, Aubiere Cedex (FR); Universite Clermont Auvergne, Clermont-Ferran (FR)

(21) Appl. No.: 17/922,247

(22) PCT Filed: Apr. 29, 2021
(86) PCT No.: PCT/EP2021/061307

§ 371 Date: Oct. 28, 2022

(30) Foreign Application Priority Data
Apr. 29, 2020 (EP) 20315228.5

(51) Int. Cl. H01M 10/0562; C01G 25/00; H01M 4/66; H01M 4/62; H01M 10/0525

(52) U.S. Cl. CPC H01M 10/0562; C01G 25/006; H01M 4/661; H01M 4/62; H01M 10/0525; C01P 2006/40; C01P 2002/52; C01P 2002/76; C01P 2002/86; C01P 2002/82; C01P 2004/03; C01P 2002/85; H01M 2300/008

(57) ABSTRACT

The invention relates to a fluorination process consisting in bringing an inorganic compound M into contact with an atmosphere comprising difluorine gas, the inorganic compound M being a garnet based on the elements Li, La, Zr, A and O and for which the relative composition of the Li, La, Zr and A cations corresponds to the formula (I): LiₓLa₃Zr_{z}A_{w}.

This application claims priority filed on Apr. 29, 2020 in EUROPE with Nr 20315228.5, the whole content of this application being incorporated herein by reference for all purposes. The present invention relates to a process for fluorination of an LLZO garnet. It also relates to the fluorinated inorganic compound obtained by said process and the use of said compound as solid electrolyte of a lithium battery.

### TECHNICAL FIELD

Garnet-type oxides have an ideal structure of chemical formula A₃B₂(XO₄)₃ and generally crystallize into a body-centered cubic lattice belonging to the Ia3̅d̅ space group. The cation sites A, B and X respectively have a coordination number with oxygen of VIII, VI and IV.

Synthetic garnets are mainly known for their magnetic and dielectric properties. However, it has been observed that certain garnets may have a high enough Li⁺ ionic conductivity to use them as solid electrolyte of lithium batteries. Thus, in 2007, teams succeeded in preparing a novel garnet of formula Li₇La₃Zr₂O₁₂ (LLZO) and obtained a total conductivity of the order of 3×10⁻⁴ S/cm. Other studies also showed that the ionic conductivity is highest when the garnet has a cubic structure rather than a tetragonal structure. Other teams have shown that the ionic conductivity was improved when the LLZO garnet comprises another chemical element such as aluminum or niobium.

Due to their high conductivity, LLZO garnets may be used as solid electrolyte in lithium batteries.

### TECHNICAL BACKGROUND

EP 2353203 B1 describes a process for preparing a garnet by a co-precipitation technique.

WO 2019/090360 describes a process for bringing an LLZO garnet into contact with a solution of a lithium salt such as LiPF₆ or LiBF₄. It is observed that the NMR spectrum given in FIG. 5 is different from that obtained with the product of the invention.

### Technical Problem

The surface of LLZO garnets is capable of being modified in contact with the moisture and CO₂ present in the atmosphere, which leads to a modification of the conductivity at the interface of the solid. This has been demonstrated for example in Phys. Chem. Chem. Phys. 2014, 16 (34), 18294-18300 https://doi.org/10.1039/c4cp02921f or in J. Mater. Chem. A 2014, 2(1), 172 181. https://doi.org/10.1039/C3TA13999A. Specifically, it is observed that LiOH and/or lithium carbonate are formed at the surface of the garnet particles when these particles are in contact with an ambient atmosphere (see also in this regard Sharafi & Sakamoto, J. Mater. Chem. A, 2017, 5, 13475).

It would therefore be useful to have garnets that have adequate ionic conductivity for use as solid electrolyte of a lithium battery and that can be stored and handled under normal conditions.

The process of the invention aims to stabilise said garnets without degrading their physicochemical properties and in particular their ionic conductivity.

### FIGURES

FIG. 1 represents the IR-ATR spectrum of the inorganic compound M of LLZO type used as starting material in the examples i.e. comparative example 1.

FIG. 2 represents the IR-ATR spectrum of the fluorinated inorganic compound of example 2. These two spectra represent the intensity of the signal in arbitrary units (au) as a function of the wave number in cm⁻¹.

FIG. 3 represents SEM-EDS analysis i.e. absolute intensity of the elements F (K lines) and La (M lines) measured as a function of the position on the line profile for fluorinated LLZO solid particles prepared according to example 1.

FIG. 4 represents SEM-EDS analysis i.e. absolute intensity of the elements F (K lines) and La (M lines) measured as a function of the position on the line profile for fluorinated LLZO solid particles prepared according to comparative example 2 (fluorinated LLZO by solid state synthesis).

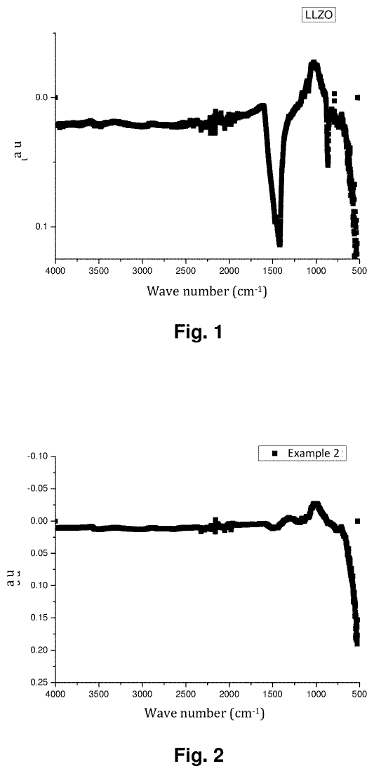

### BRIEF DESCRIPTION OF THE INVENTION

The process of the invention is described in claims 1 to 11. More precisely, the process is a fluorination process which consists in bringing an atmosphere comprising difluorine gas into contact with an inorganic compound M having a garnet-type structure, which is based on the elements Li, La, Zr, A and O and for which the relative composition of the Li, La, Zr and A cations corresponds to the formula (I):

LiₓLa₃Zr_{Z}A_{w} (I)

wherein:
A denotes at least one element chosen from the group formed of Al, Ga, Nb, Fe, W and Ta;
x, z and w denote real numbers;
1.20<z≤2.10; more particularly 1.20<z≤2.05; more particularly still 1.50≤z≤2.00;
0<w≤0.80; more particularly 0<w≤0.60; more particularly still 0<w≤0.30; more particularly still 0<w≤0.25;
4.00≤x≤10.50; more particularly 5.10≤x≤9.10; more particularly still 6.20≤x≤7.70.

The atmosphere comprising the difluorine gas is denoted by the expression “fluorinated atmosphere”.

The invention also relates to a process for fluorination of an oxide that consists

in bringing an atmosphere containing difluorine gas into contact with the oxide of formula (II):

[Liₓ₁La₃Zr_{z}A_{w}O₁₂] (II)

wherein:
A denotes at least one element chosen from the group formed of Al, Ga, Nb, Fe, W and Ta;
x1, z and w denote real numbers;
1.20<z≤2.10; more particularly 1.20<z≤2.05; more particularly still 1.50≤z≤2.00;
0<w≤0.80; more particularly 0<w≤0.60; more particularly still 0<w≤0.30; more particularly still 0<w≤0.25;
x1 is a positive real number which is such that the electroneutrality of the oxide is ensured.

The invention also relates to the fluorinated inorganic compound obtained by the process of the invention. This inorganic compound is as defined in one of claims 12 to 26.

The invention also relates to an electrode as defined in claim 27 and to the use of the fluorinated inorganic compound as defined in claims 28 and 29.

The invention will now be described in greater detail.

### DETAILED DESCRIPTION OF THE INVENTION

The starting inorganic compound M has a garnet-type structure and is based on the elements Li, La, Zr, A and O for which the relative composition of the Li, La, Zr and A cations corresponds to the formula (I):

LiₓLa₃Zr_{z}A_{w} (I)

wherein:
A denotes at least one element chosen from the group formed of Al, Ga, Nb, Fe, W and Ta;
x, z and w denote real numbers;
1.20<z≤2.10; more particularly 1.20<z≤2.05; more particularly still 1.50≤z≤2.00;
0<w≤0.80; more particularly 0<w≤0.60; more particularly still 0<w≤0.30; more particularly still 0<w≤0.25;
4.00≤x≤10.50; more particularly 5.10≤x≤9.10; more particularly still 6.20≤x≤7.70.

The inorganic compound M is a garnet based on the elements Li, La, Zr, A and O. As the element hafnium is often naturally present in the ores from which the zirconium is extracted and therefore in the starting compounds used for the preparation of the inorganic compound M, everything which is described in the present application also applies considering that the element zirconium is partially replaced by the element hafnium. Thus, the invention applies more particularly also to an inorganic compound M comprising the element hafnium. The invention may therefore apply more particularly to a starting inorganic compound M in the form of garnet based on the elements Li, La, Zr, Hf, A and O for which the relative composition of the Li, La, Zr, Hf and A cations corresponds to the formula (Ia):

LiₓLa₃(Zr₍₁₋ₐ₎+Hfₐ)_{z}A_{w} (Ia)

wherein x, z and w are as described above and a is a real number between 0 and 0.05, more particularly between 0 and 0.03, or even between 0 and 0.02.

The atomic ratio Hf/Zr=a/(1−a) is between 0 and 0.05, more particularly between 0 and 0.03, or even between 0 and 0.02. This ratio may be between 0.0006 and 0.03, or even between 0.0006 and 0.025.

A denotes at least one element chosen from the group formed of Al, Ga, Nb, Fe, W and Ta or a combination of said elements. According to a particular embodiment, A may thus denote the combination of the element Al and of an element A chosen from the group formed of Ga, Nb, Fe, W and Ta.

The inorganic compound M is electrically neutral. The anions that ensure the electroneutrality of the inorganic compound M are essentially O²⁻ anions. It is however possible that other anions such as for example OH⁻ and/or CO₃²⁻ anions contribute to the electroneutrality of the inorganic compound M.

z may be within one of the following ranges: 1.20<z≤2.10; more particularly 1.20<z≤2.05; more particularly still 1.50≤z≤2.00. More particularly, 1.90≤z≤2.10. More particularly still z≤2.00.

w may be within one of the following ranges: 0<w≤0.80; more particularly 0<w≤0.60; more particularly still 0<w≤0.30; more particularly still 0<w≤0.25. More particularly still w≥0.05.

The relative compositions of the cations may be more particularly the following:
A is chosen from the group formed of Nb, Ta or a combination of these two elements;
1.20<z≤2.10; more particularly 1.20<z≤2.05; more particularly 1.50≤z≤2.00;
0.10<w≤0.80; more particularly 0.20<w≤0.80; more particularly 0.20<w≤0.50;
6.20≤x≤10.35; more particularly 6.20≤x≤8.84; more particularly 6.50≤x≤7.48.

The relative compositions of the cations may be more particularly the following:
A denotes W;
1.20<z≤2.10; more particularly 1.20<z≤2.05; more particularly 1.50≤z≤2.00;
0.10<w≤0.80; more particularly 0.20<w≤0.80; more particularly 0.20<w≤0.50;
5.40≤x≤10.20; more particularly 5.40≤x≤8.58; more particularly 6.00≤x≤7.26.

The relative compositions of the cations may be more particularly the following:
A is chosen from the group formed of Al, Ga, Fe, or a combination of these elements;
1.90<z≤2.10; more particularly 1.95≤z≤2.05; more particularly 1.95≤z≤2.00;
0.10<w≤0.80; more particularly 0.20<w≤0.60; more particularly 0.10<w≤0.25;
4.60≤x≤10.05; more particularly 5.20≤x≤8.32; more particularly 6.25≤x≤7.37.

The empirical formula of the inorganic compound and therefore the values of the real numbers z, w and x are deduced from a chemical analysis of the inorganic compound. To do this, use may be made of the chemical analysis techniques known to those skilled in the art. Such a method may consist in preparing a solution resulting from the chemical attack of the inorganic compound M and in then determining the composition of this solution. Use may for example be made of ICP (Inductively Coupled Plasma), more particularly ICP-MS (ICP coupled with mass spectrometry) or ICP-AES (ICP coupled with atomic emission spectrometry).

The inorganic compound M has a garnet-type structure. It is considered that its crystalline structure generally consists of a skeleton of LaO₈ dodecahedra (La of coordination number 8) and of ZrO₆ octahedra (Zr of coordination number 6). More particularly, it may be composed of a skeleton of LaO₈ dodecahedra of coordination number 8 (24c site) and of ZrO₆ octahedra of coordination number 6 (16a site). In the garnet-type structure, the Li atoms may be present at the 24d tetrahedral sites or 48g and 96h octahedral sites. It is possible that most of these atoms are present at these sites.

The dopant A may itself occupy an Li or Zr site. It is considered that the dopant Al, Ga or Fe is generally at an Li site. It is considered that the dopant Nb, W and Ta is generally at a Zr site.

The inorganic compound M preferably has a cubic structure. The structure is determined using x-ray diffraction. This structure is generally described as belonging to the Ia3̅d̅ space group. It is also possible for this structure to belong to the I-43d space group, in particular when A=Ga, Fe or Al+Ga.

The inorganic compound M is prepared using LLZO garnet preparation techniques which are known to those skilled in the art. Reference may be made to the methods given by reference in Journal of the Korean Ceramic Society 2019; 56(2): 111-129 (DOI: https://doi.org/10.4191/kcers.2019.56.2.01). It is possible for example to prepare it using a solid-state method by which the oxides or salts of the constituent elements of the oxide are intimately mixed, then the mixture obtained is calcined at a high temperature, typically above 900° C. More particularly, use may for example be made of the method described in EP 2353203 B1 which comprises the following steps: (1) Li₂CO₃, La(OH)₃, ZrO₂ and an oxide, a carbonate, a hydroxide or a salt of at least one element A are intimately mixed, for example by milling in a liquid medium such as ethanol; (2) the mixture obtained is calcined in air at a temperature of at least 900° C. for a period of at least 1 hour; (3) Li₂CO₃ is intimately mixed with the calcined product, for example by milling in a liquid medium such as ethanol; (4) the mixture obtained is calcined in air at a temperature of at least 900° C., then at a temperature of at least 1100° C. Generally, an oxide of the element A is used for this synthesis. Use may be made of the precise conditions of example 1 of EP 2353203 B1 suitable for any composition of formula (I). Use may also be made of the solid-state method described in J. Mater. Chem. A, 2014, 2, 172 (DOI: 10.1039/c3ta13999a) which comprises the following steps: (1) Li₂CO₃, La(OH)₃, ZrO₂ and an oxide, a carbonate, a hydroxide or a salt of at least one element A are intimately mixed; (2) the mixture obtained is calcined in air at a temperature of at least 1000° C. for at least 10 hours; (3) the calcined product is then milled with a mortar and screened to recover only particles <75 mm which are then milled in isopropyl alcohol.

It is also possible to prepare the inorganic compound M using a co-precipitation method via which a solution comprising the salts of the elements La, Zr and A (for example a solution of conitrates) is brought into contact with a basic solution, so as to obtain a precipitate, then to bring the precipitate into contact with a lithium salt and to calcine the precipitate/lithium salt mixture at a temperature of at least 900° C. Use may be made of the precise conditions of example 1 of US 2019/0051934 suitable for any composition of formula (I).

Other methods are described in the following documents: JP 2012-224520, US 2018/0248223, US 2019/0051934 or EP 3135634 B1 (see in particular example 1).

The inorganic compound M of formula (I) comprises or essentially consists of the oxide of formula (II):

Liₓ₁La₃Zr_{z}A_{w}O₁₂ (II)

wherein A, z and w are as described above and x1 is a positive real number which is such that the electroneutrality of the oxide is ensured.

x, z and w are as described above. As regards the real number x1, it is such that the electroneutrality of the oxide is ensured. In order to do this, the proportion of the constituent elements of the oxide other than lithium, i.e. of the elements Zr, La and A and optionally Hf, is also taken into account. For the calculation of x1, the following oxidation states are also taken into account: Li+I; Zr+IV; Hf+IV; La+III; Al+III; Ga+III; Nb+V; Fe+III, W+VI; Ta+V. For example, for an oxide consisting of the elements Li, Al, La and Zr with z=1.99 and w=0.22 (as given by the chemical analysis), x1 is equal to 6.38 (x1=24−3×3−4×1.99−3×0.22).

It will be noted that in the preparation of the inorganic compound M, the calcination step or steps which are carried out at high temperatures have the effect of volatilizing lithium. To compensate for this, the lithium is generally provided in excess relative to the stoichiometry of the oxide of formula (I), so that x>x1.

That which has been described above with regard to the possible presence of the element hafnium also applies to the oxide of formula (II). Thus, it will be remembered that the invention therefore applies also to an oxide of formula (IIa):

Liₓ₁La₃(Zr₍₁₋ₐ₎+Hfₐ)_{z}O₁₂ (IIa)

x1, z and a being as described above.

The oxide of formula (II) or else of formula (IIa) is of garnet type. It is considered that its crystalline structure generally consists of a skeleton of LaO₈ dodecahedra (La of coordination number 8) and of ZrO₆ octahedra (Zr of coordination number 6). More particularly, it may be composed of a skeleton of LaO₈ dodecahedra of coordination number 8 (24c site) and of ZrO₆ octahedra of coordination number 6 (16a site). In the garnet-type structure, the Li atoms may be present at the 24d tetrahedral sites or 48g and 96h octahedral sites. It is possible that most of these atoms are present at these sites.

This oxide preferably has a cubic structure. The structure is determined using x-ray diffraction. This structure is generally described as belonging to the Ia3̅d̅ space group. It is also possible for this structure to belong to the I-43d space group, in particular when A=Ga, Fe or Al+Ga.

The fluorination is carried out by bringing the inorganic compound M (and therefore the oxide of formula (II)) into contact with an atmosphere comprising difluorine (F₂) gas.

The fluorinated atmosphere may be essentially constituted of difluorine gas. The proportion of difluorine in the atmosphere is greater than 99.0%, or even 99.5%, or even 99.9%. All these proportions are expressed as volume %. An example of an atmosphere comprising difluorine is given in the examples.

The fluorination corresponds to a reaction between a solid and a gas. It may be carried out in static mode according to which the inorganic compound M and the fluorinated atmosphere are introduced into a sealed chamber, preferably placed under vacuum beforehand, and left to react. In the case of being placed under vacuum beforehand, a low vacuum of at least 10⁻² mbar may be applied. An initial F₂ pressure of between 100 and 500 mbar may be applied. Reference may also be made to the fluorination procedure described in the article “Fluorinated nanodiamonds as unique neutron reflector”, Carbon, Volume 130, April 2018, pages 799-805 and also to the examples. According to a variant of the static mode described above (“pulsed” mode), the fluorinated atmosphere in the chamber is introduced in several goes into the sealed chamber containing the inorganic compound M and, between two additions, the fluorinated atmosphere is left to react with the solid. The static mode and the variant thereof may be carried out according to the protocol described in detail in the examples (see examples 3-4 and example 5 respectively).

The fluorination process may also advantageously be carried out in dynamic mode according to which the fluorinated atmosphere is introduced continuously into an open chamber containing the inorganic compound M. The volume flow rate (measured at 20° C. and at atmospheric pressure) of the fluorinated atmosphere which flows into the open chamber may be between 10 and 100 ml/min, more particularly between 10 and 30 ml/min. Reference may also be made to the procedure described in the article “The synthesis of microporous carbon by the fluorination of titanium carbide”, Carbon, Volume 49, Issue 9, August 2011, pages 2998-3009. The dynamic mode may be carried out according to the protocol described in detail in examples 1 and 2.

Regardless of the mode used, at the end of the fluorination, the excess difluorine, like the products of the reaction, are purged by an inert gas (such as for example N₂ or He) and neutralized in a soda lime trap positioned downstream of the reactor.

Regardless of the mode used, the total duration of the contact between the solid and the fluorinated atmosphere is between 2 minutes and 4 hours, or even between 2 minutes and 2 hours, or even between 30 minutes and 2 hours.

The fluorination is carried out at a temperature which is variable. This may be between 20° C. and 300° C., preferably between 20° C. and 250° C. It is preferably carried out at a “low” temperature, preferably between 20° C. and 50° C., so as not to degrade the physicochemical properties, in particular the conductivity, of the oxide.

Of course, from a practical point of view, regardless of the mode, it is preferable to use a chamber that is resistant to corrosion by difluorine. The material of the chamber must therefore be corrosion resistant which makes it possible to also prevent any contamination by elements present at its surface. Use may advantageously be made of a chamber made of nickel passivated by NiF₂. The solid may be placed on a plate also made of passivated nickel inserted in the chamber.

To promote contact between the solid and the gas, the solid could be arranged in the form of a bed, the thickness of which may advantageously be less than or equal to 5 mm. The inorganic compound M is preferably in the form of a powder to promote contact with the fluorinated atmosphere. This powder may have a d50 of less than 50 μm, more particularly of less than 30 μm. d50 corresponds to the median diameter of a size distribution (by volume) obtained by the laser diffraction technique on a dispersion of the solid in a liquid medium, in particular in water.

Regarding the Fluorinated Inorganic Compound

The invention also relates to the fluorinated inorganic compound which is obtained at the end of the process described above. The chemical composition of this compound corresponds essentially to that given by one of the chemical formulae given above, it being understood that the compound also comprises the element fluorine.

The invention thus also relates to an inorganic compound which has a garnet-type structure and which is based on the elements O, Li, Zr, A and optionally Hf, the relative proportions of which are those of the formula (I), this compound also comprising the element F and having at least one of the following characteristics:
a signal located between −125.0 and −129.0 ppm, more particularly between −126.0 and −128.0 ppm, more particularly still between −126.5 and −127.5 ppm, on a (¹⁹F) solid-state NMR spectrum, the reference at δ=0 ppm being that of the compound CF₃COOH;
a ratio R less than or equal to 50%, more particularly less than or equal to 40%, more particularly still less than or equal to 30% or 20% or 10%, R being the ratio between the intensity of the vibrational band of the C—O bond of the carbonate groups (symmetric stretching v) located around 1090 cm⁻¹ to the intensity of the stretching band of the bonds in the ZrO₆ octahedra located around 648 cm⁻¹, these two intensities being determined by Raman spectroscopy.

Further details are given below on the characterization of this inorganic compound.

Characterization by (¹⁹F) Solid-State NMR

The (¹⁹F) solid-state NMR spectrum of the inorganic compound may have a signal located between −125.0 and −129.0 ppm, more particularly between −126.0 and −128.0 ppm, more particularly still between −126.5 and −127.5 ppm. The chemical shifts are given by taking CF₃COOH as reference at δ=0 ppm. This signal is generally symmetrical. This signal is generally attributed to a fluorine involved in an Li—F bond.

The NMR spectrum may advantageously be obtained with magic-angle spinning of 30 kHz.

Use may more particularly be made of the measurement conditions given in the examples.

By the same spectroscopic technique and under the same conditions, it is also possible to observe a signal between −98.0 and −102.0 ppm, more particularly between −99.0 and −101.0 ppm, more particularly still between −99.5 and −100.5 ppm and/or a signal between −58.0 and −62.0 ppm, more particularly between −59.0 and −61.0 ppm, more particularly still between −59.5 and −60.5 ppm. The signals are generally attributed to the formation of La—F and Zr—F bonds respectively.

Characterization by Raman Spectroscopy

The effect of the fluorination may also be demonstrated using Raman spectroscopy. Thus, the fluorinated inorganic compound has a ratio R less than or equal to 50%, more particularly less than or equal to 40%, more particularly still less than or equal to 30% or 20% or 10%, R being the ratio between the intensity of the vibrational band of the C—O bond of the carbonate groups (symmetric stretching v) located around 1090 cm⁻¹ to the intensity of the stretching band of the bonds in the ZrO₆ octahedra located around 648 cm⁻¹.

It is generally considered that the C—O vibrational band of the carbonate groups is located at 1090±20 cm⁻¹. This band is generally located between 1080 and 1100 cm⁻¹.

It is generally considered that the stretching band of the ZrO₆ octahedra is located at 648±20 cm⁻¹. This band is generally located between 638 and 658 cm⁻¹.

It is furthermore observed that the inorganic compound may have the same R ratio after storage in an air-filled sealed flask for a period of at least two months, in particular of two months.

Characterization by Infrared Spectroscopy in Attenuated Total Reflection (ATR) Mode

The effect of the fluorination may also be demonstrated using infrared spectroscopy in attenuated total reflection (ATR) mode. Specifically, the carbonate groups have vibrational modes ν₃ and ν₂ respectively located between 1350 and 1600 cm⁻¹ and between 890 and 1350 cm⁻¹. Thus, the intensity of the vibrational mode ν₃ and/or of the vibrational mode ν₂ of the carbonate groups, these modes being respectively located between 1350 and 1600 cm⁻¹ and between 890 and 1350 cm⁻¹, is less than or equal to 50%, more particularly less than or equal to 40%, more particularly still less than or equal to 30% or 20% or 10%.

As for the R ratio, the inorganic compound may have this same intensity after storage in an air-filled sealed flask for a period of at least two months, in particular of two months.

Proportion of Fluorine

The proportion of fluorine in the compound expressed by weight of the element fluorine relative to the total weight, is generally less than or equal to 10.0%, more particularly less than or equal to 7.0%, more particularly still less than or equal to 5.0%. This proportion is generally greater than or equal to 0.01%, more particularly greater than or equal to 0.10%, more particularly still greater than or equal to 0.50%. This proportion may be between 0.01% and 10.0%, more particularly between 0.10% and 10.0%, or even between 0.10% and 7.0%. This proportion may be determined using centesimal analysis or else by ¹⁹F NMR. For the determination of the proportion of fluorine by NMR, use may be made of an internal standard containing the element fluorine, the signals of which do not coincide with those of the inorganic compound. For example, use may be made of a PVDF homopolymer. With the PVDF standard, use may in particular be made of the following formula:

$$[ F ] \% by weight = \frac{A 2}{A 1} \times \frac{m 1}{m 2} \times {[ F ]}_{PVDF}$$

with A1 the sum of the areas of the fluorine signals of the PVDF, m1 the mass of PVDF, A2 the sum of the areas of the fluorine signals of the inorganic compound, m2 the mass of the inorganic compound and [F]_{PVDF} the concentration by mass of the fluorine in the PVDF, namely 59.

It is observed that the fluorination process has the effect of reducing the amount of carbonate groups which are present, in particular at the surface of the solid, or even of making them disappear. This reduction/disappearance is gradual depending in particular on the contact time between the solid and the fluorinated atmosphere. The process of the invention therefore makes it possible to decarbonate the surface of the solid, which ensures an effective protection thereof, in particular even after storage of the solid in the open air.

The fluorination is carried out under “mild” conditions so that the crystalline structure of the starting solid is not adversely affected. In other words, the fluorinated inorganic compound has the same crystalline structure as the starting solid. It therefore preferably has a cubic structure. The structure is determined using x-ray diffraction. This structure is generally described as belonging to the Ia3̅d̅ space group. It is also possible for this structure to belong to the I-43d space group, in particular when A=Ga, Fe or Al+Ga. Furthermore, the fluorinated inorganic compound generally consists of a skeleton of LaO₈ dodecahedra (La of coordination number 8) and of ZrO₆ octahedra (Zr of coordination number 6). More particularly, it may be composed of a skeleton of LaO₈ dodecahedra of coordination number 8 (24c site) and of ZrO₆ octahedra of coordination number 6 (16a site). In the garnet-type structure, the Li atoms may be present at the 24d tetrahedral sites or 48g and 96h octahedral sites.

Furthermore, the fluorination does not generally result in a broadening of the x-ray diffraction peaks.

Use of the Fluorinated Inorganic Compound

The fluorinated inorganic compound may be used as solid electrolyte of a lithium battery. It may also be used in the preparation of a lithium battery. The fluorinated inorganic compound may be used in the preparation of an electrode E. The electrode E may be a positive electrode (Eₚ) or a negative electrode (Eₙ).

The electrode E typically comprises:
a metal support;
a layer of a composition (C) in contact with the metal substrate, said composition (C) comprising:
   (i) the fluorinated inorganic compound as described;
   (ii) at least one electroactive compound (EAC);
   (iii) optionally at least one material which conducts the Li ions other than the fluorinated oxide (LiCM);
   (iv) optionally at least one electrically-conductive material (ECM);
   (v) optionally a lithium salt (LIS);
   (vi) optionally at least one polymer binder material (P).

The term electroactive compound (EAC) denotes a compound which may incorporate lithium ions into its structure and release them during the charging and discharging of the battery. The nature of EAC varies depending on whether it is a positive or negative electrode:

1) positive electrode Eₚ

EAC may be a chalcogenide-type compound of formula LiMeQ₂ wherein:
Me denotes at least one metal chosen from the group formed of Co, Ni, Fe, Mn, Cr, Al and V;
Q denotes O or S.

EAC may more particularly be of formula LiMeO₂. Examples of EAC are given below: LiCoO₂, LiNiO₂, LiMnO₂, LiNiₓCo₁₋ₓO₂ (0<x<1), LiNiₓCo_{y}Mn_{z}O₂ (0<x, y, z<1 and x+y+z=1), Li(NiₓCo_{y}Al_{z})O₂ (x+y+z=1) and compounds having a spinel-type structure LiMn₂O₄ and Li(Ni_{0.5}Mn_{1.5})O₄.

EAC may also be a lithiated or partially lithiated compound of formula M₁M₂(JO₄)_{f}E_{1-f}, wherein:
M₁ denotes lithium, which may be partially substituted by another alkali metal;
M₂ denotes a transition metal in +2 oxidation state chosen from Fe, Mn, Ni or a combination of these elements, which may be partially substituted by at least one other transition metal with an oxidation state between +1 and +5;
JO₄ denotes an oxyanion wherein J is chosen from the list consisting of P, S, V, Si, Nb, Mo or a combination of these elements;
E denotes F, OH or CI;
f denotes the molar fraction of the JO₄ oxyanion and may be between 0.75 and 1.

EAC may also be sulfur or Li₂S.

2) Negative Electrode En

EAC may be chosen from the group formed of graphitic carbons capable of accommodating lithium in their structure. Further details on this type of EAC may be found in Carbon 2000, 38, 1031-1041. This type of EAC generally exists in the form of powders, flakes, fibers or spheres.

EAC may also be lithium metal; lithium-based compounds (such as for example those described in U.S. Pat. No. 6,203,944 or in WO 00/03444); lithium titanates generally represented by the formula Li₄Ti₅O₁₂.

ECM is typically chosen from the group of electrically-conductive carbon-based compounds. These carbon-based compounds are for example chosen from the group formed of carbon blacks, carbon nanotubes, graphites, graphenes and graphite fibers. For example, they may be carbon blacks such as ketjen black or acetylene black.

LIS may be chosen from the group formed of LiPF₆, lithium bis(trifluoromethanesulfonyl)imide, lithium bis(fluorosulfonyl)imide, LiB(C₂O₄)₂, LiAsF₆, LiClO₄, LiBF₄, LiAlO₄, LiNO₃, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiCF₃SO₃, LiAlCl₄, LiSbF₆, LiF, LiBr, LiCl, LiOH and lithium 2-trifluoromethyl-4,5-dicyanoimidazole.

The function of the polymer binder material (P) is to bind together the components of the composition (C). It is a generally inert material. It is preferably chemically stable and must allow ionic transport. Examples of materials P are given below: polymers and copolymers based on vinylidene fluoride (VDF), styrene-butadiene elastomers (SBR), copolymers of SEBS type, poly(tetrafluoroethylene) (PTFE) and copolymers of PAN type. Preferably, it is a polymer or copolymer based on VDF, for example PVDF or a copolymer based on VDF and on at least one fluorinated co-monomer other than VDF, such as hexafluoropropylene (HFP).

The proportion of the fluorinated inorganic compound in composition (C) may be between 0.1% and 80% by weight, this proportion being expressed by weight of the fluorinated oxide relative to the total weight of the composition. This proportion may be between 1.0% and 60.0% by weight, or even between 10.0% and 50.0% by weight.

The thickness of the electrode (E) is not limited and should be adapted to the energy and to the power necessary for the intended application. Thus, this thickness may be between 0.01 and 1000 mm.

The fluorinated inorganic compound may also be used in the preparation of a battery separator (SP). A separator denotes a permeable membrane between the anode and the cathode of a battery. Its role is to be permeable to the lithium ions while stopping the electrons and while ensuring the physical separation between the electrodes. The separator (SP) of the invention typically comprises:
the fluorinated inorganic compound;
at least one polymer binder material (P);
at least one metal salt, for example a lithium salt;
optionally a plasticizer.

The electrode (E) and the separator (SP) may be prepared using techniques known to those skilled in the art. These techniques generally consist in mixing the components in an appropriate solvent and in then eliminating this solvent. Thus, for example, the electrode (E) may be prepared by the process comprising the following steps:
a dispersion comprising the components of the composition (C) and at least one solvent is applied on a metal support;
the solvent is then eliminated.

The techniques for preparing the electrode (E) and the separator (SP) described in the journal Energy Environ. Sci., 2019, 12, 1818 may be used.

Should the disclosure of any patents, patent applications, and publications which are incorporated herein by reference conflict with the description of the present application to the extent that it may render a term unclear, the present description shall take precedence.

### EXAMPLES

¹⁹F NMR Spectroscopy

Solid-state NMR of the ¹⁹F nucleus is carried out on a Bruker 400 MHz solid-state Avance Neo or Bruker 300 MHz Avance spectrometer with magic-angle spinning (MAS) at a spin rate of 30 or 26 kHz. The chemical shifts are referenced relative to CF₃COOH (δ=0 ppm) (observation: δ (CF₃COOH)=78.5 ppm vs CFCl₃).

Measurement conditions: a single π/2 pulse is used with a recycle delay D₁ of 30 s. The number of pulses is adjusted to obtain a high signal/noise ratio (typically 128 or 256 pulses).

Fluorine Assay

The quantification of the fluorine was carried out by ¹⁹F MAS-NMR (Magic Angle Spinning). Use was made of a BRUKER 400 MHz Avance Neo spectrometer equipped with a 1.9 mm probe. PVDF (SOLEF® 1015/1001 from Solvay) was used as internal standard and the ¹⁹F reference used is trifluoroacetic acid (6=0 ppm).

From 25 to 80 mg of sample and from 2 to 5 mg of PVDF are weighed using a precision balance. A homogeneous mixture of these two solids is prepared using a powder mixer, for example by means of 5 minutes of three-dimensional mixing in the Turbula mixer from WAB. Around 25 mg of this mixture is compacted in a 1.9 mm rotor and is introduced into the spectrometer. The samples are analysed with a single pulse sequence with a spin rate of 26 kHZ, a pulse of 1.5 ms and a relaxation time D1 of 30 seconds.

The NMR spectrum is decomposed by integrating the signals on NMR Notebook. The areas of the PVDF signals (main signals and rotational bands) are added up, in the same way as for the signals attributed to the fluorine present in the sample.

The weight percentage of fluorine in the sample is given according to the following formula:

$$[ F ] \% by weight = \frac{A 2}{A 1} \times \frac{m 1}{m 2} \times {[ F ]}_{PVDF}$$

with A1 the sum of the areas of the fluorine signals of the PVDF, ml the mass of PVDF, A2 the sum of the areas of the fluorine signals of the inorganic compound, m2 the mass of the inorganic compound and [F]_{PVDF} the concentration by mass of the fluorine in the PVDF, namely 59.

Raman Spectroscopy

The products are analysed by Raman spectroscopy on a T64000 spectrometer from the company Jobin-Yvon equipped with a confocal microscope. The spectra were recorded after storing for 2 months in a sealed flask under ambient conditions. The incident laser used is an ionized argon laser operating at 514.5 nm. The incident power of the laser is 100 mW. The Raman analyses were carried out in the range 250-1500 cm⁻¹, with acquisition times of 60 s for each window with a spectral width of 500 cm⁻¹, repeated twice.

Infrared Spectroscopy in ATR Mode

The IR spectra were recorded between 400 and 4000 cm⁻¹ using a Nicolet 380 FT-IR (Thermo-electron) Fourier transform spectrophotometer. The spectra were recorded after storing for 2 months in a sealed flask under ambient conditions. Each spectrum is composed of 128 scans with a resolution of 4 cm⁻¹. The background is automatically subtracted by the device.

Scanning Electron Microscopy—Energy Dispersive Spectroscopy Analysis

### (SEM-EDS)

Operating procedure for SEM-EDS characterization:

The powder is embedded in a Epofix resin which polymerizes at room temperature over 24h.

After polymerization, the solid block which contains the powder undergoes a section on a microtome setup (Reichert & Jung Ultracut E model) under dry conditions; therefore the section of some solid particles is accessible.

Then the surface of the preparation is treated by a platinum sputtering, under secondary vacuum, in a Cressington 208HR sputtercoater. The deposited thickness is a few nanometers.

The preparation is introduced in a SEM FEG LEO 1525. SEM EDS analysis is performed at 8 kV, with diaphragm 60 μm and working distance 8.5 mm. The EDS spectrum is analysed by an Oxford SDD 80 mm² detector X Max N, cooled by Peltier effect. Data treatment is conducted under AZTEC software V4.4, after beam optimization on a silicon standard. Line profiles are acquired at magnification 2000, with 500 data points on a length which is typically 20 μm. Under those conditions at 8 kV, the analysed volume is ≤1 μm³.

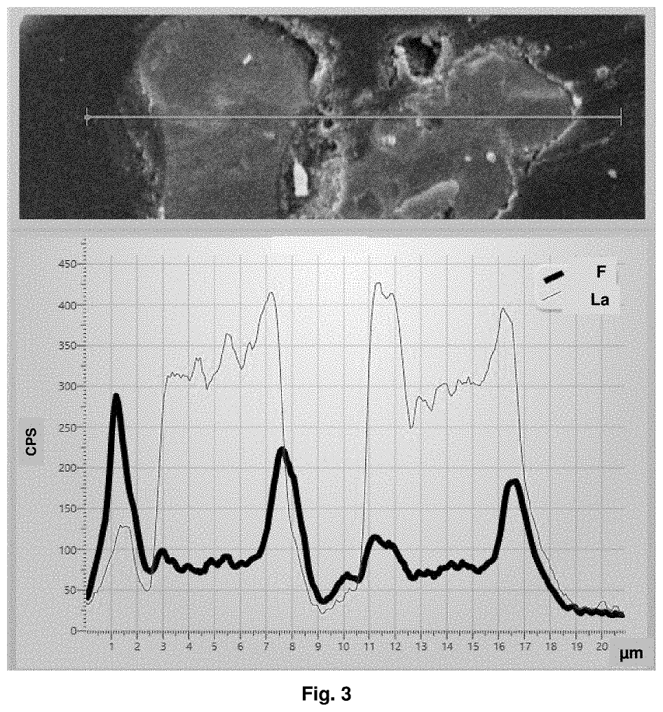

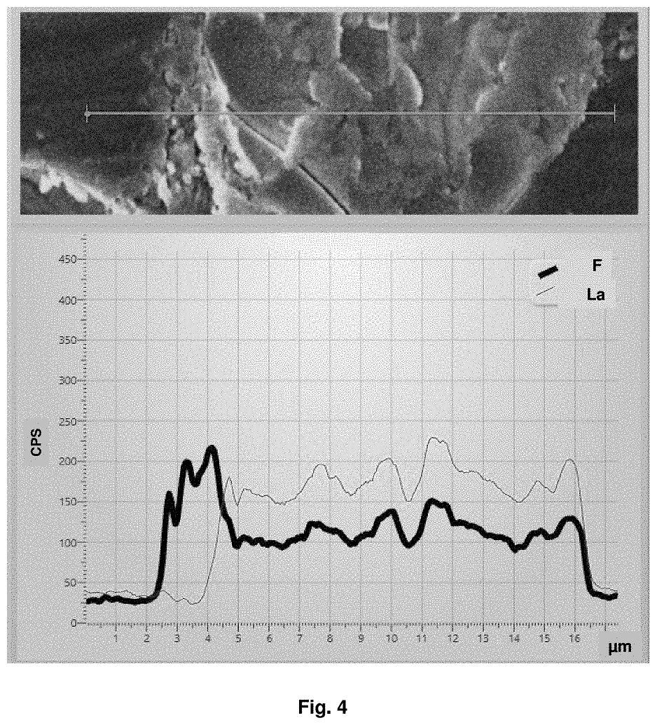

The absolute intensity of the elements F (K lines) and La (M lines) is measured as a function of the position on the line profile. Results are reported in FIG. 3 and FIG. 4.

X-Ray Photoelectron Spectroscopy (XPS)

Operating procedure for surface elemental analysis by XPS:

The powder sample is pressed on an indium pellet. The XPS instrument is a THERMO K-alpha+ with monochromatized AlKα X-ray source. The data treatment software is Avantage. The atomic concentrations are obtained from high resolution spectra for each element.

XPS analysis is conducted on samples “as is” and also after etching by Ar⁺ ions. In order to give an order of magnitude of the sputtered thickness, we refer to the sputtering rate of SiO₂ in the following results.

The analytical and instrumental specifications are as follows:
take-off angle: 90°;
depth of analysis: lower than 10 nm (average 3 nm);
spot diameter: 400 μm;
all elements are detectable, except H et He;
sensitivity limits: from 0.1% to 0.5% atomic;
quantitative analysis:
accuracy 10 to 20%;
precision 2 to 5% (relative) depending on the concentration.

Results of XPS analysis are reported in table 2.

The inorganic compound M that was used is an Al-doped LLZO obtained by the method described in J. Mater. Chem. A 2014, 2(1), 172-181. (https://doi.org/10.1039/C3TA13999A). The cations have the following relative composition determined by ICP: Li_{6.97}La₃Zr_{1.98}Al_{0.22}.

For the fluorination, use was made of an atmosphere of 99.9% pure difluorine (F₂) (with an HF impurity level <0.5 vol % and an O₂/N₂ impurity level of around 0.5 vol %).

Example 1: fluorination in dynamic mode at ambient temperature for 1 hour

336.5 mg of M are deposited in a passivated nickel boat in the form of a bed of powder, the thickness of which is less than 2 mm. The plate is inserted into a 1-liter passivated nickel reactor at 25° C. A 20 ml/min flow of F₂ is continuously introduced into the reactor over 1 hour. At the end of the test, a 50 ml/min flow of N₂ is used over 60 minutes to purge the reactor of any trace of residual F₂. A mass uptake of 1.1 mg is observed after the experiment, expressing the incorporation of fluorine into the compound M.

Example 2: fluorination in dynamic mode at ambient temperature for 2 hours

The conditions of example 1 are repeated with an initial mass of M of 402.7 mg of M and a time of 2 hours instead of 1 h. A mass uptake of 1.8 mg is observed after the experiment, expressing the incorporation of fluorine into the compound M.

Example 3: fluorination in static mode at ambient temperature for 1 hour

Around 500 mg of the compound M are deposited in a passivated nickel boat as a bed of powder with a thickness of less than 2 mm. The plate is inserted into the 1-liter reactor at 25° C. A pressure of 200 mbar of F₂ is imposed in the reactor over 1 hour. The temperature is not monitored in the reactor and corresponds to ambient temperature, of the order of 25° C. At the end of the test, a 50 ml/min flow of N₂ is used over 60 minutes to purge the reactor of any trace of F₂.

Example 4: static fluorination at 200° C.

509.3 mg of the compound M are deposited in a passivated nickel boat as a bed of powder with a thickness of less than 2 mm. The plate is inserted into the 1-liter reactor at 25° C. A pressure of 200 mbar of F₂ is imposed in the reactor throughout the experiment. The temperature of the reactor is monitored and a ramp of 2° C./min is imposed up to 200° C., then the reactor is left to cool freely under a flow of N₂ (50 ml/min) to ambient temperature, i.e around 1 h 30 min.

Example 5: fluorination in pulsed mode

592.2 mg of the compound M are deposited in a passivated nickel boat as a bed of powder with a thickness of less than 2 mm. The plate is inserted into the 1-liter reactor at 25° C. Metered additions of 20 mbar of F₂ are carried out every 2 minutes in the reactor until a pressure of 200 mbar is reached. At the end of the test, a 50 ml/min flow of N₂ is used for 60 minutes to purge the reactor of any trace of F₂. A mass uptake of 5.0 mg is observed after the experiment, expressing the incorporation of fluorine into the compound M.

Example 6: fluorination in static mode at ambient temperature for 18 hours

Around 500 mg of the compound M are deposited in a passivated nickel boat as a bed of powder with a thickness of less than 2 mm. The plate is inserted into a 1-liters reactor at 25° C. A pressure of 1000 mbar of F₂ is imposed in the reactor in 3 steps. The temperature is not monitored in the reactor and corresponds to ambient temperature, of the order of 25° C.
1) 500 mbar of N₂ are added in the reactor with a flow rate of 500 ml/min;
2) 200 mbar of F₂ are added in the reactor with a flow rate of 150 ml/min;
3) 300 mbar of N₂ are added in the reactor with a flow rate of 500 ml/min.

It takes 14 minutes to perform the 3 steps. The pressure of 1000 mbar of the reactive mixture, 20% F₂/80% N₂ in volume, is imposed in the reactor throughout the experiment i.e. during 18h.

At the end of the test, a 500 ml/min flow of N₂ is used over 60 minutes to purge the reactor of any trace of F₂.

Comparative example 1: compound M is used without being submitted to any fluorination.

Comparative example 2: preparation of a fluorinated LLZO by solid state synthesis

The solid state synthesis is done by mixing 5.24 g of Li₂CO₃ (99.9% Sigma Aldrich) 9.72 g of La₂O₃ (99% SigmaAldrich), 4.93 g of ZrO₂ (SigmaAldrich), 0.21 g of Al₂O₃(Sigma Aldrich, precalcinated 2H at 600° C.), and 0.51g of LiF (SigmaAldrich). The targeted stoechiometry is Li_{6.4}La₃Al_{0.2}Zr₂O₁₂+1.5 LiF, and the targeted fluorine content is thus 3.3% wt.

Step 1: Powders are mixed with 66g of 5 mm zirconia balls (prior dried in an oven at 65° C.) and put in turbula device for 2 hours to homogeneize them.

The balls are then separated from the powder, and the powder is put in alumina crucible (rectangle shape) covered with alumina lid.

The powder is then calcined at 900° C. during 12 hours under air with 5° C./min ramp heating and 2° C./min cooling followed by a plateau at 100° C., to avoid any moisture uptake at the end of the calcination, before being recovered at 50° C.

Step 2: The resulting powder is mixed in turbula with 66g of 5 mm zirconia balls (dried in at oven 65° C.).

The balls are then separated from the powder, and the powder is put in alumina crucible (rectangle shape) covered with alumina lid.

The powder is then calcined at 1000° C. during 12 hours with 5° C./min ramp heating and 2° C./min cooling followed by a plateau at 100° C., to avoid any moisture uptake at the end of the calcination, before being recovered at 50° C.

Step 3: The resulting powder is mixed in turbula with 66g of 5 mm zirconia balls (dried in oven 65° C.).

The balls are then separated from the powder, and the powder is put in alumina crucible (rectangle shape) covered with alumina lid.

The powder is then calcined at 1100° C. during 12 hours in furnace F1300 with 5° C./min ramp heating and 2° C./min cooling followed by a plateau at 100° C., to avoid any moisture uptake at the end of the calcination, before being recovered at 50° C.

The XRD of the sample shows the presence of cubic LLZO (95% wt measured by HighScore software) with minor traces of La₂Zr₂O₇ (5% wt measured by HighScore software).

Some results are given in table I. The following observations can be made:

¹⁹F NMR: on all the samples brought into contact with the fluorinated atmosphere, a symmetric signal is observed at −127±2 ppm vs CF₃COOH which demonstrates the presence of Li—F bonds. For certain samples, additional signals appear toward −100 ppm and −60 ppm vs CF₃COOH, expressing the appearance of new chemical surroundings for the ¹⁹F nuclei.

Raman spectroscopy: all the spectra have peaks characteristic of a cubic LLZO, namely:
peaks at 354 cm⁻¹ and at 508 cm⁻¹ characteristic of the deformation modes of the octahedral units based on ZrO₆;
a peak at 648 cm⁻¹ characteristic of the stretching modes of these same units.

An additional peak can also be observed around 1090 cm⁻¹ on all the products except that of example 2. This peak is attributed to the (symmetric stretching) vibration of the C—O bonds of a carbonate group (cf. Zhang Z, Zhang L, Liu Y, Wang H, Yu C, Zeng H, Wang LM, Xu B, Interface-Engineered Li₇La₃Zr₂O₁₂-Based Garnet Solid Electrolytes with Suppressed Li-Dendrite Formation and Enhanced Electrochemical Performance, Chem Sus Chem 2018, 11, 3774-3782).

IR-ATR spectroscopy: the main vibrational modes are linked to the vibrations ν₃ and ν₂ of the carbonates at 1409-1460 cm⁻¹ and 879 cm⁻¹. These bands disappear almost completely for the LLZO treated for 2 h in dynamic mode. A series of bands at 626, 679, 847, 1002, 2800 and 3613 cm⁻¹ is sometimes observed in certain products and conveys the presence of LiOH.

TABLE I

| | | | ¹⁹F NMR | | | |
|---|---|---|---|---|---|---|
| | | | | peaks | | |
| | | | peak | at −60 | IR-ATR | |
| | | % F (by | at −127 | and −100 | presence | Raman |
| | fluorination | weight) | ppm | ppm | of LiOH | R ratio |
| Comparative ex 1 | none | 0% | no | no | no | 41 |
| Comparative ex 2 | Solid-state synthesis | * | yes* | * | | |
| ex 1 | Difluorine gas dynamic 1 h | 0.7% | yes | no | no | 6 |
| ex 2 | Difluorine gas dynamic 2 h | 3.3% | yes | yes | no | 0 |
| ex 3 | Difluorine gas static | 0.9% | yes | no | yes | 41 |
| | 25° C., 1 h | | | | | |
| ex 4 | Difluorine gas static | | yes | no | yes | 50 |
| | 200° C. | | | | | |
| ex 5 | Difluorine gas pulsed | 0.5% | yes | yes | yes | 58 |
| Ex 6 | Difluorine gas static | | | | | 12 |
| | 25° C., 18 h | | | | | |

*By ¹⁹F solid-state NMR, an additional peak centred at around −40 ppm is evidenced. It is a broad signal which is not present in the products of the examples according to the invention attributed to a different ¹⁹F environment in the product obtained by solid-state synthesis. The presence of this signal prevents one from quantifying the fluor content by the above described NMR quantification method. The peak at around −127 ppm is present.

It is observed that the dynamic mode makes it possible to obtain a solid having a very low R ratio compared to the static mode. However, it is also possible to obtain a solid having a low R ratio when increasing the reaction time in the static mode (see ex 6).

In dynamic mode, it is observed that % of F by weight in the resulting solid is increasing with the time of reaction (see ex 1 and ex 2) and accordingly, it is concluded that one can control the fluorine content in the sample, at least by monitoring the reaction time.

Results of SEM-EDS analysis, as reported in FIG. 3 and FIG. 4, show the distribution of Fluorine and Lanthanum elements along the section of fluorinated LLZO solid particles, respectively prepared by gaseous fluorination according to example 2 and by solid phase synthesis according to comparative example 2. On one hand, FIG. 3 shows that fluorine is concentrated on the surface of the particle, while the core of the particle is “lanthanum rich”, in the case of fluorinated LLZO solid particles prepared by gaseous fluorination. On the other hand, FIG. 4 shows that, when the fluorinated LLZO solid particles are prepared by solid phase synthesis, fluorine and lanthanum are homogeneously dispersed all along the section of the particles.

The applicants have shown that gaseous fluorination allows advantageously operating fluorination localized mainly on the surface of the LLZO particles.

Results of XPS analysis are reported in table 2 below. The ratios C/Zr and F/Zr are expressed in function of material depth. Results show that the carbon/C content (C which is assumed to come from the carbonate species identified by IR and/or Raman spectroscopy) decreases with the material depth. More surprisingly, whatever the analysis depth, the C content is much lower for the fluorinated product of example 2 vs the comparative example 1. This is directly correlated to a higher amount of fluorine in the product of example 2.

This result is consistent with the conclusion that the fluorination process according to the invention has the effect of reducing the amount of carbonate groups which are present, in particular at the surface of the solid.

It is worth noting that the fluorine content in example 2 decreases with the depth, which is in good agreement with SEM-EDS results.

TABLE 2

| | | C/Zr | F/Zr |
|---|---|---|---|
| Comparative | Surface | 95.5 | 1.0 |
| example 1 | 15 nm | 37.0 | 0.7 |
| | 50 nm | 12.9 | 0.3 |
| Example 2 | Surface | 28.0 | 30.6 |
| | 15 nm | 8.1 | 25.0 |
| | 50 nm | 3.1 | 22.4 |

Evidences above show: i) that gaseous fluorination allows advantageously operating fluorination localized mainly on the surface of the LLZO particles, ii) that this fluorination is accompanied by removal of carbonate species on said surface and iii) that this fluorination protects said surface from further carbonate formation.

1. A fluorination process comprising bringing an atmosphere comprising difluorine gas into contact with an inorganic compound M having a garnet-type structure, which is based on the elements Li, La, Zr, A and O and for which the relative composition of the Li, La, Zr and A cations corresponds to the formula (I):
LiₓLa₃Zr_{z}A_{w} (I)
wherein:
A denotes at least one element selected from the group consisting of Al, Ga, Nb, Fe, W and Ta;
x, z and w denote real numbers;
1.20<z≤2.10;
0<w≤0.80;
4.00≤x≤10.50;
the duration of the contact between the solid and the fluorinated atmosphere is between 2 minutes and 4 hours; and
the temperature at which the fluorination is carried out is between 20° C. and 300° C.

2. The process as claimed in claim 1, wherein the inorganic compound M comprises the oxide of formula (II):
Liₓ₁La₃Zr_{z}A_{w}O₁₂ (II)
wherein z and w are as defined in claim 1 and x1 is a positive real number which is such that the electroneutrality of the oxide is ensured.

3. A fluorination process comprising bringing an atmosphere containing difluorine gas into contact with the oxide of formula (II):
[Liₓ₁La₃Zr_{z}A_{w}O₁₂] (II)
wherein:
A denotes at least one element selected from the group consisting of Al, Ga, Nb, Fe, W and Ta;
x1, z and w denote real numbers;
1.20<z≤2.10;
0<w≤0.80; and
x1 is a positive real number which is such that the electroneutrality of the oxide is ensured.

4. The process as claimed in claim 1, wherein the element zirconium is partially replaced by the element hafnium.

5. (canceled)

6. (canceled)

7. (canceled)

8. (canceled)

9. (canceled)

10. (canceled)

11. (canceled)

12. A garnet-type inorganic compound based on the elements Li, La, Zr, A, O and optionally Hf which is obtained by the process as described in claim 1.

13. An inorganic compound having a garnet-type structure based on the elements O, Li, Zr, A, the relative proportions of which are those of the formula (I):
LiₓLa₃Zr_{z}A_{w} (I)
wherein:
A denotes at least one element selected from the group consisting of Al, Ga, Nb, Fe, W and Ta;
x, z and w denote real numbers;
1.20<z≤2.10;
0<w≤0.80; and
4.00≤x≤10.50;
this compound also comprising the element F and having at least one of the following characteristics:
a signal located between −125.0 and −129.0 ppm on a (¹⁹F) solid-state NMR spectrum, the reference at δ=0 ppm being that of the compound CF₃COOH; and
a ratio R less than or equal to 50%, R being the ratio between the intensity of the vibrational band of the C—O bond of the carbonate groups (symmetric stretching v) located around 1090 cm⁻¹ to the intensity of the stretching band of the bonds in the ZrO₆ octahedra located around 648 cm⁻¹, these two intensities being determined by Raman spectroscopy.

14. The inorganic compound as claimed in claim 13, wherein the element zirconium is partially replaced by the element hafnium.

15. (canceled)

16. The inorganic compound as claimed in claim 12, the crystalline structure of which consists of a skeleton of LaO₈ dodecahedra (La of coordination number 8) and of ZrO₆ octahedra (Zr of coordination number 6).

17. The inorganic compound as claimed in claim 12, the crystalline structure of which consists of a skeleton of LaO₈ dodecahedra of coordination number 8 (24c site) and of ZrO₆ octahedra of coordination number 6 (16a site).

18. The inorganic compound as claimed in claim 12, wherein some Li atoms, are present at the 24d tetrahedral sites or 48g and 96h octahedral sites.

19. The inorganic compound as claimed in claim 12, comprising La—F and/or Zr—F bonds.

20. The inorganic compound as claimed in claim 12, having, by (¹⁹F) solid-state NMR spectroscopy, the reference at δ=0 ppm being that of the compound CF₃COOH, a signal between −98.0 and −102.0 ppm and/or a signal between −58.0 and −62.0 ppm.

21. The inorganic compound as claimed in claim 12, of which the proportion of fluorine in the compound expressed by weight of the element fluorine relative to the total weight, is less than or equal to 10.0%, and is greater than or equal to 0.01%.

22. (canceled)

23. The inorganic compound as claimed in claim 12, having a cubic crystal structure.

24. The organic compound as claimed in claim 23, to which the crystal structure belongs to the Ia3̅d̅ space group or to the I-43d space group.

25. The inorganic compound as claimed in claim 12, having a ratio R less than or equal to 50%, R being the ratio between the intensity of the vibrational band of the C—O bond of the carbonate groups (symmetric stretching v) located around 1090 cm⁻¹ to the intensity of the stretching band of the bonds in the ZrO₆ octahedra located around 648 cm⁻¹, these two intensities being determined by Raman spectroscopy and R being determined after storing the inorganic compound in an air-filled sealed flask for a period of at least two months, in particular of two months.

26. The inorganic compound as claimed in claim 12, characterized in that the intensity of the vibrational mode ν₃ and/or of the vibrational mode ν₂ of the carbonate groups, these modes being respectively located between 1350 and 1600 cm⁻¹ and between 890 and 1350 cm⁻¹, is less than or equal to 50%, this intensity being determined by infrared spectroscopy in total attenuated reflectance mode.

27. An electrode E comprising:
a metal support;
a layer of a composition (C) in contact with the metal substrate, said composition (C) comprising:
(i) the inorganic compound as claimed in claim 12;
(ii) at least one electroactive compound (EAC);
(iii) optionally at least one material which conducts the Li ions other than the fluorinated oxide (LiCM);
(iv) optionally at least one electrically-conductive material (ECM);
(v) optionally a lithium salt (LIS); and
(vi) optionally at least one polymer binder material (P).

28. A solid electrolyte of a lithium ion battery comprising the inorganic compound as described in claim 12.

29. A method of preparing a lithium battery, the method comprising: preparing an electrode comprising the inorganic compound as described in claim 12.
